(19) United States
(12) Patent Application Publication
(10) Pub. No.: US 2012/0064408 A1
(43) Pub. Date: Mar. 15, 2012

(54) POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(75) Inventors: Hyun-Kon Song, Ulju-gun (KR); Myeong-Hee Lee, Ulju-gun (KR); Jin-Young Kim, Ulju-gun (KR); Soojin Park, Ulju-gun (KR); Jaephil Cho, Ulju-gun (KR)

(73) Assignee: UNIST Academy-Industry Research Corporation, Ulsan (KR)

(21) Appl. No.: 12/909,934

(22) Filed: Oct. 22, 2010

(30) Foreign Application Priority Data
Sep. 10, 2010 (KR) 10-2010-0088964

(51) Int. Cl. H01M 4/485; H01M 4/90; H01M 4/525; H01M 4/583; H01M 4/52

(52) U.S. Cl. 429/220; 429/221; 252/182.1

(57) ABSTRACT

Provided is a positive active material for a lithium rechargeable battery that includes primary particles including a compound being capable of intercalating and deintercalating lithium, and secondary particles including the primary particles gathered with one another, wherein the secondary particles have a void core structure. A method of preparing the same and a lithium rechargeable battery including the same are also provided.

### CROSS-REFERENCE TO RELATED APPLICATION

This application claims priority to and the benefit of Korean Patent Application No. 10-2010-0088964 filed in the Korean Intellectual Property Office on Sep. 10, 2010, the entire contents of which are incorporated herein by reference.

### BACKGROUND OF THE INVENTION

(a) Field of the Invention

This disclosure relates to a positive active material for a lithium rechargeable battery, a method of preparing the same, and a lithium rechargeable battery including the same.

(b) Description of the Related Art

Batteries generate electrical power using electrochemical active materials for a positive electrode and a negative electrode. Rechargeable lithium batteries generate electrical energy from changes of chemical potential during the intercalation/deintercalation of lithium ions at the positive and negative electrodes.

The rechargeable lithium batteries include materials that reversibly intercalate or deintercalate lithium ions during the charge and discharge for positive and negative active materials, and also include an organic or a polymer electrolyte between the positive and negative electrodes.

As for the negative active material of a rechargeable lithium battery, various carbon-based materials such as artificial graphite, natural graphite, and hard carbon, which can all intercalate and deintercalate lithium ions, have been used.

For the positive active material for a rechargeable lithium battery, a composite metal oxide such as LiCoO₂, LiMn₂O₄, LiNiO₂, LiNi₁₋ₓCoₓO₂ (0<x<1), LiMnO₂, LiFePO₄, and so on has been researched. Recently, there has been increasing research on LiFePO₄ having high energy density, a low cost, high stability, and environment-friendly characteristics.

### SUMMARY OF THE INVENTION

One aspect of the present invention provides a positive active material for a lithium rechargeable battery having improved lithium ion accessibility, diffusion rate of lithium ions, and electrical conductivity.

Another aspect of the present invention provides a method of preparing the positive active material for a lithium rechargeable battery.

Yet another aspect of the present invention provides a lithium rechargeable battery including the positive active material.

According to one aspect of the present invention, a positive active material for a lithium rechargeable battery is provided that includes primary particles including a compound being capable of intercalating and deintercalating lithium, and secondary particles including the primary particles gathered with one another. The secondary particles have a void core structure.

The primary particles may include a lithium iron phosphate particle represented by the following Chemical Formula 1 and carbon.

Liᵢ₊ₐFe₁₋ₓMₓ(PO_{4-b})X_{b} [Chemical Formula 1]

In Chemical Formula 1,

M is Al, Mg, Ni, Co, Mn, Ti, Ga, Cu, V, Nb, Zr, Ce, In, Zn, Y, or a combination thereof,

X is F, S, N, or a combination thereof, and

−0.5≦a≦0.5, 0≦x≦0.5, and 0≦b≦0.1.

The compound represented by Chemical Formula 1 may include LiFePO₄.

The carbon may be amorphous.

The carbon may be present on the surface of the lithium iron phosphate particle.

The carbon may be coated on a part or the entire surface of the lithium iron phosphate particle. Herein, the carbon may be coated to be about 2 nm to about 6 nm thick.

The primary particles may have an average particle diameter ranging from about 25 nm to about 70 nm.

The secondary particles may have a spherical shape or an oval shape.

The cross-section of the secondary particles shows that they have a void space in the core. The void space is formed by the connected surfaces of the primary particles gather with one another.

The secondary particles may have an average particle diameter ranging from about 200 nm to about 500 nm.

The positive active material for a lithium rechargeable battery may include about 1 wt % to about 5 wt % of carbon based on the total weight of the positive active material.

According to another aspect of the present invention, provided is a method of preparing a positive active material for a lithium rechargeable battery, which includes: preparing a first mixture including a first precipitate by mixing a lithium source, a phosphate source, and a solvent; preparing a second mixture by mixing a carbon source, an iron source, and a solvent; and forming a second precipitate by mixing the first and second mixtures and forming a coprecipitate of the first and second precipitates.

The lithium source may be included in an amount of about 5 wt % to about 15 wt %, the phosphate source may be included in an amount of about 80 wt % to about 85 wt %, and the solvent may be included as a balance to form a first precipitate.

The lithium source may include lithium hydroxide monohydrate (LiOH.H₂O), lithium hydroxide (LiOH), lithium nitrate (LiNO₃), lithium chloride (LiCl), or a combination thereof.

The phosphate source may include phosphoric acid (H₃PO₄), diammonium phosphate ((NH₄)₂HPO₄), ammonium phosphate trihydrate ((NH₄)₃PO₄.3H₂O), or a combination thereof.

The first precipitate may include lithium phosphate (Li₃PO₄).

In addition, the carbon source may be included in an amount of about 25 wt % to about 30 wt %, the iron source may be included in an amount of about 35 wt % to about 40 wt %, and the solvent may be included as a balance to prepare a second mixture.

The carbon source may include a surfactant including a compound represented by the following Chemical Formula 2, a carbon gel, a carbohydrate, ascorbic acid, citric acid, or a combination thereof.

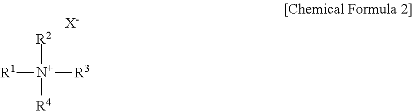

In Chemical Formula 2,

R¹ to R⁴ are independently hydrogen or a substituted or unsubstituted C1 to C30 aliphatic organic group, and

X is F, Cl, Br, or I.

The iron source may include iron(II) sulfate heptahydrate (FeSO₄.7H₂O), ammonium iron(II) sulfate ((NH₄)₂Fe(SO₄)₂), or a combination thereof.

The second precipitate may include iron(II) phosphate (Fe₃(PO₄)₂).

The solvent may include H₂O, a polyol, or a combination thereof.

The processes of mixing first and second mixtures to form a second precipitate and of forming a coprecipitate of the first and second precipitates are performed at a temperature ranging from about 20° C. to about 40° C.

The method of preparing a positive active material for a lithium rechargeable battery may further including hydrothermally reacting the coprecipitate under a pressure ranging from about 3 kPa to about 4 kPa at a temperature ranging from about 115° C. to about 130° C.

The method of preparing a positive active material for a lithium rechargeable battery may further include heat treatment of the coprecipitate.

The heat treatment may be performed under an inert or reduction atmosphere at a temperature ranging from about 650° C. to about 750° C.

According to another embodiment of the present invention, provided is a lithium rechargeable battery including a positive electrode including the positive active material, a negative electrode including a negative active material, and an electrolyte.

Other aspects of the present invention are described in the detailed description.

According to one embodiment of the present invention, a positive active material for a lithium rechargeable battery has a void core structure and thus facilitates lithium ion accessibility, improving the output characteristic of a lithium rechargeable battery.

### BRIEF DESCRIPTION OF THE DRAWINGS

FIG. 1 is a schematic view showing a secondary particle according to one embodiment of the present invention.

FIG. 2 is a cross-sectional view showing a secondary particle according to one embodiment of the present invention.

FIG. 3 shows X-ray diffraction patterns of the positive active materials for a lithium rechargeable battery according to Example 1 and Comparative Example 1.

FIG. 4 is a scanning electron microscope (SEM) image of a coprecipitate of lithium phosphate (Li₃PO₄) and iron(II) phosphate (Fe₃(PO₄)₂) after the hydrothermal reaction according to Example 1.

FIG. 5 is a transmission electron microscope (TEM) image of a coprecipitate of lithium phosphate (Li₃PO₄) and iron(II) phosphate (Fe₃(PO₄)₂) after the hydrothermal reaction according to Example 1.

FIG. 6 is a scanning electron microscope (SEM) image of a positive active material according to Example 1.

FIG. 7 is a transmission electron microscope (TEM) image of a positive active material according to Example 1.

FIG. 8 is a scanning electron microscope (SEM) image of a positive active material according to Comparative Example 1.

FIG. 9 is a transmission electron microscope (TEM) image of a positive active material according to Comparative Example 1.

FIG. 10 is a schematic view showing the structure of a lithium rechargeable battery according to one embodiment of the present invention.

FIGS. 11A and 11B respectively show discharge capacity graphs of half-coin cells according to Example 2 and Comparative Example 2.

### DETAILED DESCRIPTION

Exemplary embodiments of the present disclosure will hereinafter be described in detail referring to the following accompanied drawings and can be easily performed by those who have common knowledge in the related art. However, these embodiments are only exemplary, and the present invention is not limited thereto.

In the drawings, the thickness of layers, films, panels, regions, etc., are exaggerated for clarity. Like reference numerals designate like elements throughout the specification.

It will be understood that when an element such as a layer, a film, a region, or a substrate is referred to as being “on” another element, it can be directly on the other element, or an intervening element may also be present. In contrast, when an element is referred to as being “directly on” another element, there are no intervening elements present.

As used herein, when a specific description is not otherwise provided, the term “substituted” refers to a functional group substituted with a substituent selected from the group consisting of a halogen (F, Br, Cl or I), a hydroxy group, a nitro group, a cyano group, an amino group (NH₂, NH(R²⁰⁰) or N(R²⁰¹)(R²⁰²), wherein R200, R²⁰¹, and R²⁰² are independently a C1 to C10 alkyl group), an amidino group, a hydrazine group, a hydrazone group, a carboxyl group, a substituted or unsubstituted alkyl group, a substituted or unsubstituted haloalkyl group, a substituted or unsubstituted alkoxy group, a substituted or unsubstituted alkenyl group, a substituted or unsubstituted alkynyl group, a substituted or unsubstituted aryl group, a substituted or unsubstituted heteroaryl group, and a substituted or unsubstituted heterocycloalkyl group instead of at least one hydrogen.

As used herein, when a specific description is not otherwise provided, the term “aliphatic” refers to a C1 to C30 alkyl, a C2 to C30 alkenyl, a C2 to C30 alkynyl, a C1 to C30 alkylene, a C2 to C30 alkenylene, or a C2 to C30 alkynylene, more specifically a C1 to C20 alkyl, a C2 to C20 alkenyl, a C2 to C20 alkynyl, a C1 to C20 alkylene, a C2 to C20 alkenylene, or a C2 to C20 alkynylene, and still more specifically a C1 to C15 alkyl, a C2 to C15 alkenyl, a C2 to C15 alkynyl, a C1 to C15 alkylene, a C2 to C15 alkenylene, or a C2 to C15 alkynylene.

As used herein, when a specific description is not otherwise provided, the term “heterocycloalkyl group” and “heteroaryl group” independently refer to a cycloalkyl group and an aryl group including 1 to 3 heteroatoms of N, O, S, Si, or P in one ring and carbon for the rest.

As used herein, when a specific description is not otherwise provided, the term “alkyl group” refers to a C1 to C20 alkyl group, specifically a C1 to C15 alkyl group, and more specifically a C1 to C10 alkyl group, the term “cycloalkyl group” refers to a C3 to C20 cycloalkyl group, specifically a C3 to C15 cycloalkyl group, and more specifically a C3 to C10 cycloalkyl group, the term “alkenyl group” refers to a C2 to C20 alkenyl group, specifically a C2 to C15 alkenyl group, and more specifically a C2 to C10 alkenyl group, the term “alkynyl group” refers to a C2 to C20 alkynyl group, specifically a C2 to C15 alkynyl group, and more specifically a C2 to C10 alkynyl group, the term “alkoxy group” refers to a C1 to C20 alkoxy group, specifically a C1 to C15 alkoxy group, and more specifically a C1 to C10 alkoxy group, the term “aryl group” refers to a C6 to C30 aryl group, specifically a C6 to C20 aryl group, and more specifically a C6 to C15 aryl group, and the term “heterocycloalkyl group” refers to a C2 to C30 heterocycloalkyl group, and specifically a C2 to C20 heterocycloalkyl group.

According to one embodiment of the present invention, a positive active material for a lithium rechargeable battery includes primary particles including a compound being capable of intercalating and deintercalating lithium, and secondary particles including the primary particles gathered with one another. The secondary particles have a void core structure

When the positive active material for a lithium rechargeable battery includes a secondary particle with a void core structure, it has an enlarged specific surface area and improved lithium ion accessibility, and may effectively promote intercalation/deintercalation of lithium ions. Accordingly, the positive active material for a lithium rechargeable battery may improve the output characteristic.

The primary particles may include a lithium iron phosphate particle represented by the following Chemical Formula 1 and carbon, but are not limited thereto.

Liᵢ₊ₐFe₁₋ₓMₓ(PO_{4-b})X_{b} [Chemical Formula 1]

In Chemical Formula 1,

M is Al, Mg, Ni, Co, Mn, Ti, Ga, Cu, V, Nb, Zr, Ce, In, Zn, Y, or a combination thereof,

X is F, S, N, or a combination thereof, and

−0.5≦a≦0.5, 0≦x≦0.5, and 0≦b≦0.1.

The primary particles includes a lithium iron phosphate particle including a compound represented by the above Chemical Formula 1, and thus may effectively intercalate/deintercalate lithium ions and improve stability.

The primary particles include the carbon and thereby improve electrical conductivity and facilitate electron transportation, improving the output characteristic of a lithium rechargeable battery.

The compound represented by Chemical Formula 1 may include LiFePO₄, but is not limited thereto.

The carbon may be amorphous. The carbon may prevent or relieve pulverization of the lithium iron phosphate particles, even when the lithium iron phosphate particles have a volume change due to the lithium intercalation and deintercalation, and may also prevent and decrease the side reaction of the lithium iron phosphate particles with an electrolyte.

The carbon may be present on a surface of the lithium iron phosphate particles, but is not limited thereto.

The carbon may be coated on a part or the entire surface of the lithium iron phosphate particles. Because lithium ions in lithium iron phosphate move only in one direction, the movement of electrons is restrictive. However, the carbon which is independently coated on the lithium iron phosphate particles may vary paths of electrons and promote their movement.

The carbon may be coated to be about 2 nm to about 6 nm thick on the surface of the lithium iron phosphate particle. When the carbon coating has a thickness within the range, it may effectively vary a path for electrons, further promoting their movement. In particular, the carbon may be coated to be about 3 nm to about 4 nm thick.

The primary particles may have an average particle diameter ranging from about 25 nm to about 70 nm. When the primary particles have an average particle diameter within the range, they may shorten a moving distance of lithium ions and promote intercalation/deintercalation of the lithium ions. Specifically, the primary particles may have an average particle diameter of about 30 nm to about 50 nm.

The secondary particles may have a spherical shape or an oval shape, but are not limited thereto.

Specifically, the cross-section of the secondary particles shows a void space in the core, which is formed by the connected surfaces of primary particles aggregated with one another.

The secondary particles may have an average particle diameter of about 200 nm to about 500 nm, specifically about 200 nm to about 400 nm, and more specifically about 250 nm to about 350 nm, but are not limited thereto.

The positive active material for a lithium rechargeable battery may include carbon in an amount of about 1 wt % to about 5 wt % based on the total weight of the positive active material for a lithium rechargeable battery. When the carbon is included within the range, the positive active material for a lithium rechargeable battery may improve electrical conductivity and thus the battery characteristic. In particular, the carbon may be included in an amount of about 1 wt % to about 3 wt %, and more particularly in an amount of about 1.5 wt % to about 2 wt %.

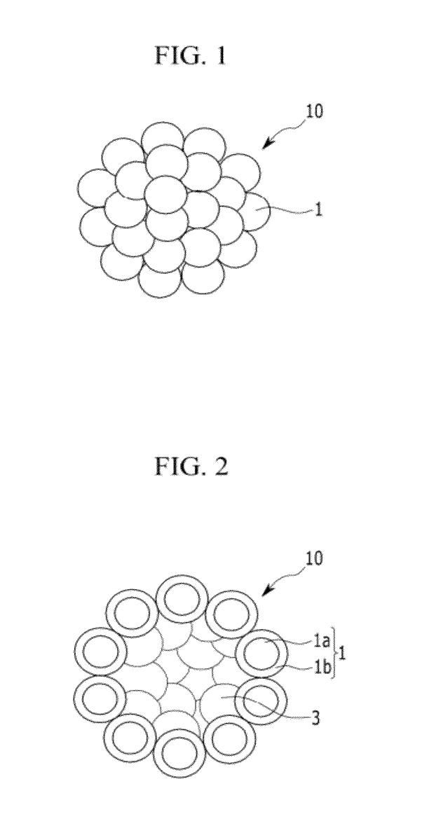

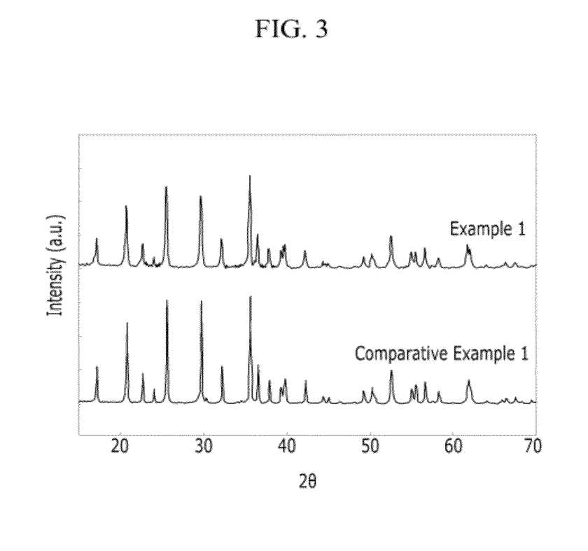

Referring to FIGS. 1 and 2, secondary particles included in a positive active material for a lithium rechargeable battery according to one embodiment of the present invention are illustrated.

FIG. 1 is a schematic view showing the secondary particle 10, and FIG. 2 is a cross-sectional view of the secondary particle 10. However, the secondary particle is not limited thereto.

Referring to FIGS. 1 and 2, the secondary particle 10 may be formed by primary particles 1 including a lithium iron phosphate particle 1a and a carbon coating 1b on the surface of the lithium iron phosphate particle 1a. The secondary particle 10 includes a void space 3 in the core. In other words, as shown in FIG. 2, the void space 3 in the core of the secondary particle 10 is formed by the connected surface of the primary particles 1.

According to another embodiment of the present invention, provided is a method of preparing a positive active material for a lithium rechargeable battery, which includes: preparing a first mixture including a first precipitate by mixing a lithium source, a phosphate source, and a solvent; preparing a second mixture by mixing a carbon source, an iron source, and a solvent; and mixing the first and second mixtures to prepare a second precipitate and preparing a coprecipitate of the first and second precipitates.

The method of preparing the positive active material for a lithium rechargeable battery may effectively prepare a secondary particle having a void core structure by using a solubility product constant difference of the materials.

When the lithium source, phosphate source, and solvent are mixed to prepare a first precipitate, the lithium source may be included in an amount of about 5 wt % to about 15 wt %, the phosphate source in an amount of about 80 wt % to about 85 wt %, and the solvent as a balance. When each component is included within the range, it may yield more of the first precipitate and effectively form a second precipitate and a coprecipitate of the first and second precipitates. In particular, the lithium source may be included in an amount of about 9.7 wt % to about 11 wt %, the phosphate source in an amount of about 80 wt % to about 85 wt %, and the solvent as a balance. More particularly, the lithium source may be included in an amount of about 10.2 wt % to about 10.5 wt %, the phosphate source in an amount of 83 wt % to 84 wt %, and the solvent as a balance.

The lithium source may include lithium hydroxide monohydrate (LiOH.H₂O), lithium hydroxide (LiOH), lithium nitrate (LiNO₃), lithium chloride (LiCl), or a combination thereof, but is not limited thereto.

The phosphate source may include phosphoric acid (H₃PO₄), diammonium phosphate ((NH₄)₂HPO₄), ammonium phosphate trihydrate ((NH₄)₃PO₄.3H₂O), or a combination thereof, but is not limited thereto.

The prepared first precipitate may include lithium phosphate (Li₃PO₄), but is not limited thereto. The first precipitate may be prepared by reacting lithium ions of the lithium source and phosphate ions of the phosphate source.

When the carbon source, the iron source, and the solvent are mixed to prepare a second mixture, the carbon source may be included in an amount of about 25 wt % to about 30 wt %, the iron source in an amount of about 35 wt % to about 40 wt %, and the solvent as a balance. When each component is mixed within the range, it may improve the yield of a second precipitate and a coprecipitate thereof. In addition, the first precipitate, a second precipitate described later, and a coprecipitate thereof may be effectively surrounded with carbon source on the surface in situ. In particular, the carbon source may be included in an amount of about 28 wt % to about 29 wt %, the iron source in an amount of about 37 wt % to about 38 wt %, and the solvent as a balance.

The carbon source may include a surfactant including a compound represented by the following Chemical Formula 2, a carbon gel, a carbohydrate, ascorbic acid, citric acid, or a combination thereof, but is not limited thereto.

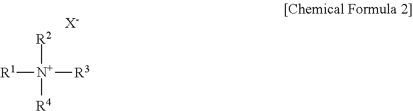

In Chemical Formula 2,

R¹ to R⁴ are independently hydrogen or a substituted or unsubstituted C1 to C30 aliphatic organic group, and

X is F, Cl, Br, or I.

The carbon source may surround the surface of the first precipitate, a second precipitate described later, and a coprecipitate thereof, and then may be decomposed by heat treatment and coated on the surface of the primary particles.

In particular, the surfactant may be a hexadecyl trimethyl ammonium bromide (CTAB) aqueous solution, but is not limited thereto.

The iron source may include iron(II) sulfate heptahydrate (FeSO₄.7H₂O), ammonium iron(II) sulfate ((NH₄)₂Fe(SO₄)₂) or a combination thereof, but is not limited thereto.

The second precipitate may include iron(II) phosphate (Fe₃(PO₄)₂), but is not limited thereto. The second precipitate may be formed through reaction of iron ions of the iron source and phosphate ions of the phosphate source or phosphate ions eluted when the first precipitate is dissolved. Herein, the first precipitate may be partly dissolved due to a solubility product constant difference of the mixed materials and principle of mobile equilibrium (Le Chatelier's principle). Accordingly, they form a secondary particle with a void space in the core.

In addition, the coprecipitate may be formed as a mixture of the first and second precipitates. The coprecipitate may be a precursor for forming the aforementioned primary particles.

The solvent may include H₂O, a polyol, or a combination thereof, but is not limited thereto.

The step of mixing the first and second mixtures to prepare a second precipitate and forming a coprecipitate of the first and second precipitates may be performed at a temperature ranging from about 20° C. to about 40° C., in particular, from about 20° C. to about 25° C., and more in particular, from about 21° C. to about 22° C., but is not limited thereto.

The method of preparing a positive active material for a lithium rechargeable battery may further include hydrothermally-reacting the coprecipitate under a pressure ranging from about 3 kPa to about 4 kPa at a temperature ranging from about 115° C. to 130° C. When further hydrothermally reacted, a particle may be prevented from excessive growth, efficiently forming a precipitate. In particular, the hydrothermal reaction may be performed under a pressure ranging from about 3.4 kPa to about 3.6 kPa at a temperature ranging from about 119° C. to about 121° C.

On the other hand, the method of preparing a positive active material for a lithium rechargeable battery may further include heat treating the coprecipitate.

When the coprecipitate is heat treated, the first and second precipitates included in the coprecipitate may react with each other and form a particle including a compound with one composition. The particle including a compound with one composition may be a lithium iron phosphate particle represented by the above Chemical Formula 1.

In addition, the coprecipitate may be heat treated to decompose a carbon source surrounding the first and second precipitates and the coprecipitate and to coat carbon on the surface of the lithium iron phosphate particle.

The heat treatment may be performed under an inert or reduction atmosphere. In particular, the inert atmosphere may be an argon (Ar) or nitrogen (N₂) atmosphere, and the reduction atmosphere may be a hydrogen (H₂) atmosphere, but is not limited thereto.

The heat treatment may be performed at a temperature ranging from about 650° C. to about 750° C. When the heat treatment is performed within the temperature range, the lithium iron phosphate particles may be prevented from excessive growth or aggregation among themselves, efficiently forming the lithium iron phosphate particles. In particular, the heat treatment may be performed at a temperature ranging from about 690° C. to about 710° C.

Accordingly, the method according to one embodiment of the present invention may provide a positive active material for a lithium rechargeable battery including a secondary particle with a void space in the core by performing sequential precipitations and using the solubility product constant and the principle of mobile equilibrium.

This process may provide a positive active material for a rechargeable lithium battery according to one embodiment of the present invention.

The positive active material according to one embodiment of the present invention may be usefully applied to a positive electrode for an electrochemical cell such as a rechargeable lithium battery. The rechargeable lithium battery may include a negative electrode including a negative active material and an electrolyte as well as the positive electrode.

The positive electrode includes a current collector and a positive active material layer disposed on the current collector.

The positive active material layer may include a binder and a conductive material.

The binder improves binding properties of the positive active material particles to one another, and also with a current collector. Examples of the binder include at least one selected from the group consisting of polyvinyl alcohol, carboxylmethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may be included to improve electrode conductivity. It may include any electrically conductive material unless it causes a chemical change. Examples of the conductive material include one or more of natural graphite, artificial graphite, carbon black, acetylene black, ketjen black, carbon fiber, a metal powder or a metal fiber including copper, nickel, aluminum, silver, and the like, and polyphenylene derivatives.

The current collector may be Al, but is not limited thereto.

The negative electrode includes a current collector and a negative active material layer formed on the current collector. The negative active material layer includes the negative active material.

The negative active material may include a material that reversibly intercalates/deintercalates lithium ions, a lithium metal, a lithium metal alloy, a material being capable of doping and dedoping lithium, or a transition metal oxide.

The material that can reversibly intercalate/deintercalate lithium ions includes a carbon material. The carbon material may be any generally-used carbon-based negative active material in a lithium ion rechargeable battery. Examples of the carbon material include crystalline carbon, amorphous carbon, and a combination thereof. The crystalline carbon may be non-shaped, or sheet, flake, spherical, or fiber shaped natural graphite or artificial graphite. The amorphous carbon may be a soft carbon, a hard carbon, mesophase pitch carbide, fired coke, and the like.

Examples of the lithium metal alloy include lithium and a metal selected from the group consisting of Na, K, Rb, Cs, Fr, Be, Mg, Ca, Sr, Si, Sb, Pb, In, Zn, Ba, Ra, Ge, Al, or Sn.

Examples of the material being capable of doping and dedoping lithium include Si, SiOₓ (0<x<2), a Si-M alloy (where M is an element selected from the group consisting of an alkali metal, an alkaline-earth metal, a group 13 element, a group 14 element, a transition element, a rare earth element, and a combination thereof, and is not Si), Sn, SnO₂, a Sn-M (where M is an element selected from the group consisting of an alkali metal, an alkaline-earth metal, a group 13 element, a group 14 element, a transition element, a rare earth element, and a combination thereof, and is not Sn). At least one of these materials may be mixed with SiO₂. The element M may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, and the like.

The negative active material layer includes a binder and optionally a conductive material.

The binder improves binding properties of negative active material particles with one another and with a current collector. Examples of the binder include at least one selected from the group consisting of polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. It may include any electrically conductive material unless it causes a chemical change. Examples of the conductive material include: carbon-based materials such as natural graphite, artificial graphite, carbon black, acetylene black, ketjen black, carbon fiber, and the like; metal-based materials of metal powder or metal fiber including copper, nickel, aluminum, silver, and the like; conductive polymers such as polyphenylene derivatives; or mixtures thereof.

The current collector may be selected from the group consisting of a copper foil, a nickel foil, a stainless steel foil, a titanium foil, a nickel foam, a copper foam, a polymer substrate coated with a conductive metal, and combinations thereof.

The positive and negative electrodes may be fabricated in a method that includes mixing the active material, a conductive material, and a binder into an active material composition and coating the composition on a current collector. The electrode-manufacturing method is well known and thus is not described in detail in the present specification. The solvent may be N-methylpyrrolidone, but it is not limited thereto.

The electrolyte charged for a rechargeable lithium battery may include a non-aqueous electrolyte, a solid electrolyte, or the like, in which a lithium salt is dissolved.

The solvent for a non-aqueous electrolyte includes, but is not limited to, cyclic carbonates such as ethylene carbonate, diethylene carbonate, propylene carbonate, butylene carbonate, vinylene carbonate, and the like, linear carbonates such as dimethyl carbonate, ethylmethyl carbonate, diethyl carbonate, and the like, esters such as methyl acetate, ethyl acetate, propyl acetate, methyl propionate, ethyl propionate, y-butyrolactone, and the like, ethers such as 1,2-dimethoxyethane, 1,2-diethoxyethane, tetrahydrofuran, 1,2-dioxane, 2-methyltetrahydrofuran, nitriles such as acetonitrile, and amides such as dimethyl formamide. They may be used singularly or in plural. In particular, they may include a mixed solvent of a cyclic carbonate and a linear carbonate.

In addition, the electrolyte may include a gel-type polymer electrolyte prepared by impregnating an electrolyte solution in a polymer electrolyte such as polyethylene oxide, polyacrylonitrile, and the like, or an inorganic solid electrolyte such as Lil and Li₃N, but is not limited thereto.

The lithium salt includes at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlO₂, LiAlCl₄, LiCl, and LiI, but is not limited thereto.

The rechargeable lithium battery may further include a separator between the negative and positive electrodes, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

Rechargeable lithium batteries may be classified as lithium ion batteries, lithium ion polymer batteries, and lithium polymer batteries according to the presence of a separator and the kind of electrolyte used therein. The rechargeable lithium batteries may have a variety of shapes and sizes. In other words, they may include cylindrical, prismatic, coin, or pouch-type batteries, and may be thin film batteries or may be rather bulky in size. Structures and fabricating methods for lithium ion batteries pertaining to the present invention are well-known in the art.

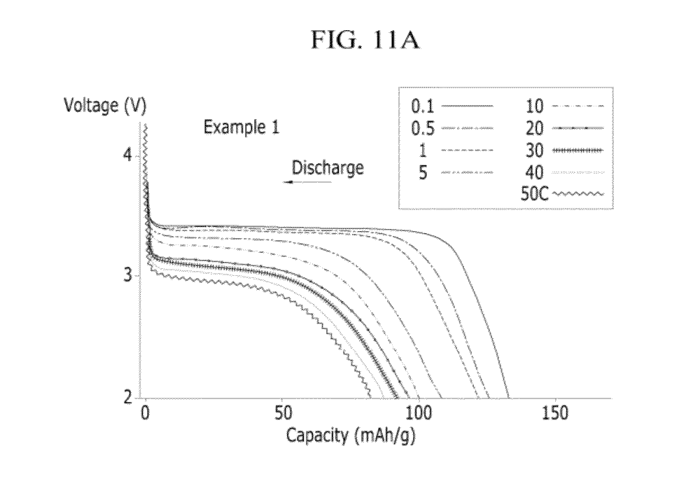

FIG. 10 is a schematic view showing the representative structure of a rechargeable lithium battery. As shown in FIG. 10, the lithium rechargeable battery 100 includes a negative electrode 112, a positive electrode 114, a separator 113 interposed between the negative electrode 112 and the positive electrode 114, an electrolyte solution (not shown) impregnating the separator 113, a battery case 120, and a sealing member 140 sealing the battery case 120. The rechargeable lithium battery of the present invention has no specific limit in shape, and may be formed into diverse shapes such as a cylindrical shape, a coin-type shape, and a pouch shape, as long as it operates as a battery.

### EXAMPLES

The following examples illustrate the present invention in more detail. However, it is understood that the present invention is not limited by these examples.

### Example 1

### Preparation of Positive Active Material for a Lithium Rechargeable Battery

12 ml of a 2.5 M lithium hydroxide monohydrate (LiOH.H₂O) aqueous solution is mixed with 0.684 ml of a 14.6 M phosphoric acid (H₃PO₄) aqueous solution, preparing a lithium phosphate (Li₃PO₄) precipitate. The lithium phosphate precipitate may be prepared according to the following Reaction Scheme 1.

3LiOH.H₂O+H₃PO₄→Li₃PO₄(s)+6H₂O [Reaction Scheme 1]

Next, 5 ml of a 0.8 M hexadecyl trimethyl ammonium bromide (CTAB) aqueous solution dissolved at 35° C. and 8 ml of a 1.25 M iron(II) sulfate heptahydrate (FeSO₄.7H₂O) aqueous solution are mixed together. The mixture is added thereto to co-precipitate a lithium phosphate (Li₃PO₄) precipitate and an iron(II) phosphate (Fe₃(PO₄)₂) precipitate at 25° C. The coprecipitate may be prepared according to the following Reaction Scheme 2.

Li₃PO₄(s)+FeSO₄.7H₂O→1/3Fe₃(PO₄)₂(s)+1/3Li₃PO₄(s)+2Li⁺+SO₄²⁻+7H₂O [Reaction Scheme 2]

Then, a solution including the coprecipitate is put in a 30 ml high-pressure reactor (autoclave) and reacted at 120° C. for 5 hours under a hydrothermal condition. When the reaction is complete, the reactor is cooled to room temperature. The coprecipitate is filtrated while washed with distilled water and then, dried in a 100° C. vacuum oven for one hour.

The dried coprecipitate is heat-treated under argon (Ar) atmosphere at 700° C. for 6 hours, preparing a positive active material for a lithium rechargeable battery. The positive active material for a lithium rechargeable battery may be prepared according to the following Reaction Scheme 3.

1/3Fe₃(PO₄)₂(s)+1/3Li₃PO₄(s)→LiFePO₄ [Reaction Scheme 3]

### Comparative Example 1

### Preparation of Positive Active Material for a Lithium Rechargeable Battery

A commercially-available LiFePO₄ (Phostech Lithium Inc. SC-P2) is used as a positive active material for a lithium rechargeable battery.

### Example 2

### Fabrication of a Lithium Rechargeable Battery

The positive active material for a lithium rechargeable battery according to Example 1 is mixed with a polyvinylidene fluoride (PVdF) binder and Super P carbon black in a weight ratio of 80:10:10 in N-methylpyrrolidone (NMP), preparing a slurry. Next, the slurry is uniformly coated on an aluminum foil using a doctor blade coater, and is then vacuum-dried at 130° C. for 20 minutes, fabricating a positive electrode.

The positive electrode and a lithium foil as a counter electrode are used together with a porous polyethylene layer (Celgard 2300, thickness: 25 μm, Celgard LLC) as a separator to fabricate a 2016R type half-coin cell in a common process. The coin cell includes an electrolyte solution prepared by dissolving LiPF₆ with a concentration of 1.15 M in a mixed solvent of ethylene carbonate and dimethyl carbonate in a volume ratio of 3:7.

### Comparative Example 2

### Fabrication of a Lithium Rechargeable Battery

A 2016R type coin-cell is fabricated according to the same method as in Example 2 except for using a positive active material for a lithium rechargeable battery according to Comparative Example 1 instead of the positive active material for a lithium rechargeable battery according to Example 1.

### Experimental Example 1

### X-Ray Diffraction (XRD) Analysis

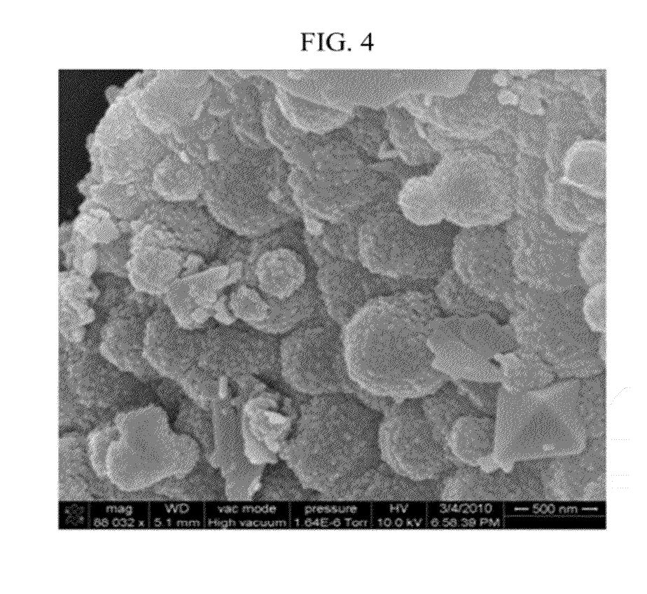

X-ray diffraction analysis was performed regarding the positive active materials according to Example 1 and Comparative Example 1. The results are provided in FIG. 3.

The X-ray diffraction is used a Cu—Kα ray as a light source.

As shown in FIG. 3, the positive active material of Example 1 is identified as LiFePO₄, since it has the same reference data as LiFePO₄ of Comparative Example 1.

### Experimental Example 2

### Scanning Electron Microscope (SEM) and Transmission Electron Microscope (TEM) Images

The coprecipitate hydrothermally-reacted and dried in Example 1 and the positive active materials according to Example 1 and Comparative Example 1 were respectively sampled on a carbon tape, platinum (Pt) plasma-coated, and then got SEM images. In addition, a solution including a specimen dispersed therein is sampled on a carbon-coated copper grid, dried, and then got TEM images. Herein, a field-emission scanning electron microscope (FE-SEM) (NanoSem 230, FEI Co.) and a high resolution transmission electron microscope (HR-TEM) (JEM-2100F, JEOL Ltd.) working at 200 kV are used.

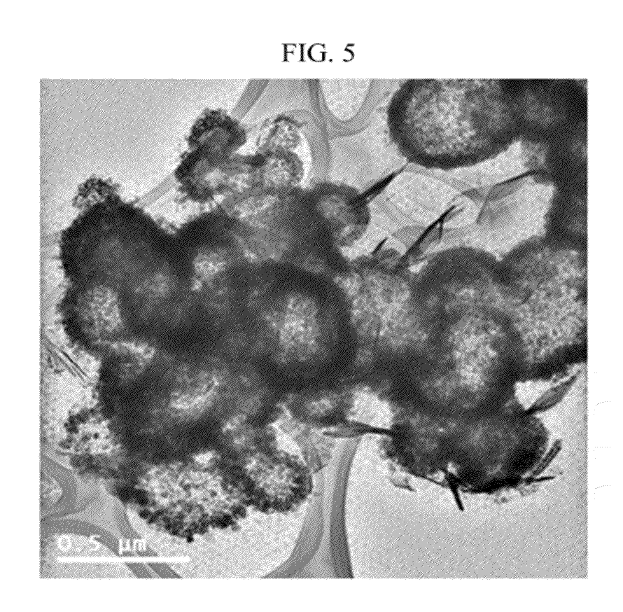

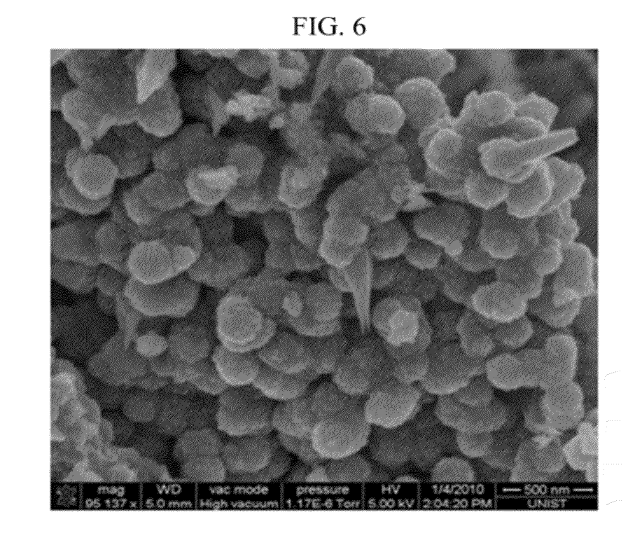

FIG. 4 shows a scanning electron microscope image taken of the coprecipitate dried and hydrothermally-reacted in Example 1. FIG. 5 shows its transmission electron microscope image.

As shown in FIGS. 4 and 5, the coprecipitate according to Example 1 includes primary particles with a particle diameter ranging from about 50 nm to about 70 nm. The primary particles form a spherical secondary particle having a void core and a diameter ranging from about 200 nm to about 500 nm.

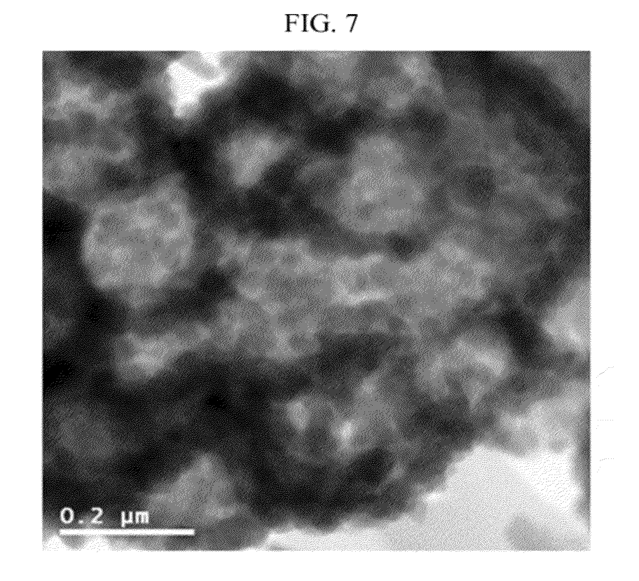

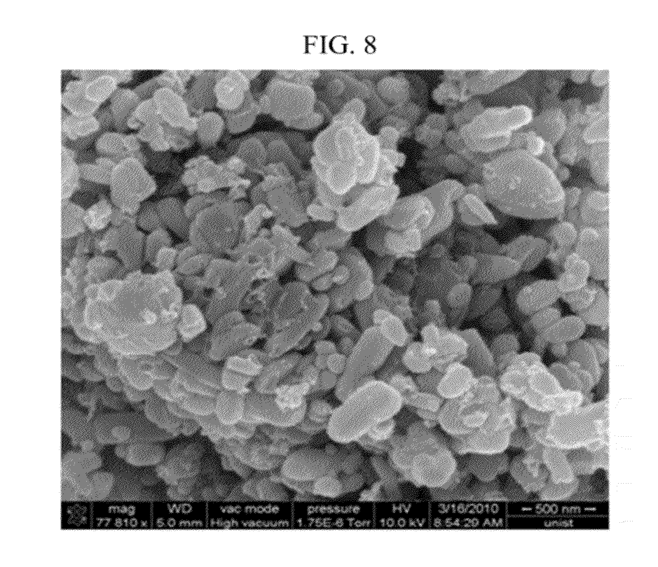

FIG. 6 shows a scanning electron microscope image of the positive active material according to Example 1. FIG. 7 shows its transmission electron microscope image.

As shown in FIGS. 6 and 7, the positive active material according to Example 1 includes primary particles with a particle diameter ranging from about 50 nm to about 70 nm. The primary particles form a spherical secondary particle having a void core and a diameter ranging from about 200 nm to about 300 nm.

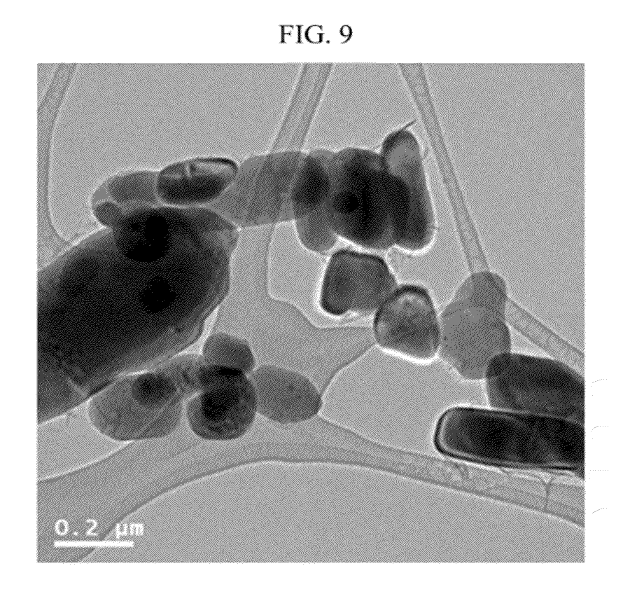

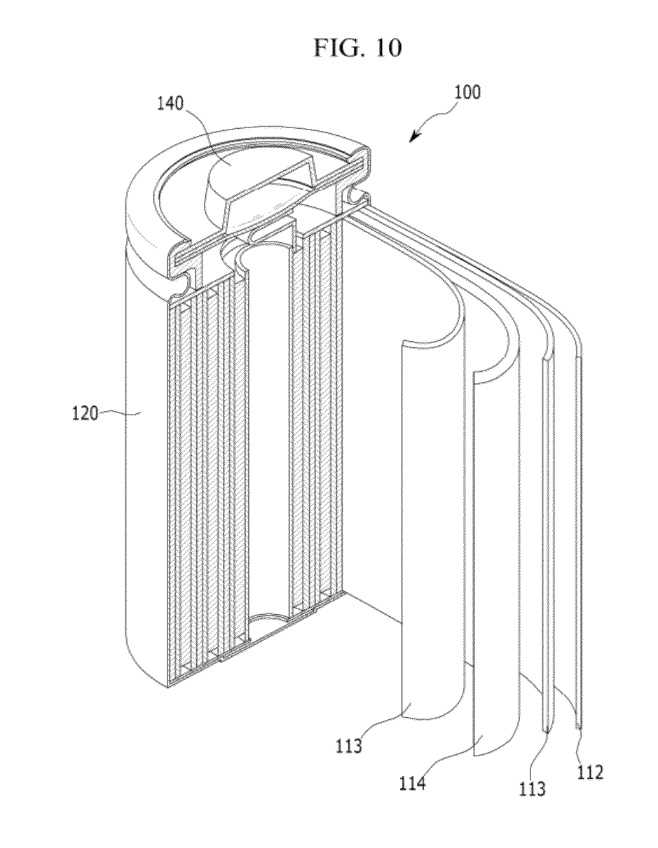

FIG. 8 shows a scanning electron microscope image of the positive active material according to Comparative Example 1. FIG. 9 shows its transmission electron microscope image.

As shown in FIGS. 8 and 9, the positive active material according to Comparative Example 1 includes replete primary particles with a particle diameter ranging from about 100 nm to about 500 nm.

### Experimental Example 3

### Capacity Characteristics

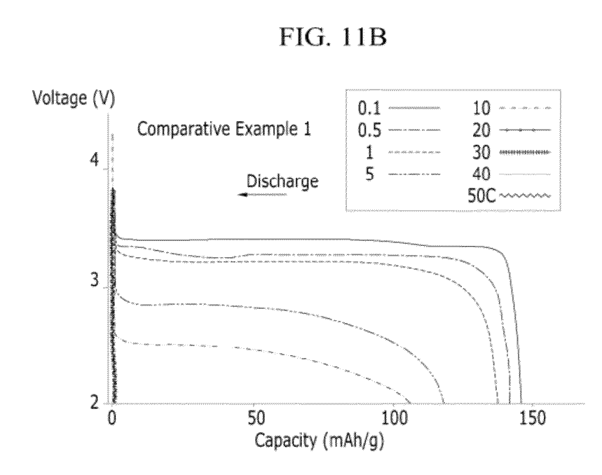

Each half-coin cell according to Example 2 and Comparative Example 2 is repeatedly charged at 1 C-rate and discharged at 0.1 C-rate, 0.5 C-rate, 1 C-rate (150 mA/g), 5 C-rate, 10 C-rate, 20 C-rate, 30 C-rate, 40 C-rate, and 50 C-rate. The result is provided in FIGS. 11A and 11B, and the following Table 1.

TABLE 1

Discharge capacity (mAh/g)

| C-rate | Example 2 | Comparative Example 2 |
|---|---|---|
| 0.1 C | 132.2 | 145.9 |
| 0.5 C | 125.3 | 141.8 |
| 1 C | 121.8 | 137.1 |
| 5 C | 107.9 | 118.4 |
| 10 C | 100.0 | 107.2 |
| 20 C | 96.4 | 0.5 |
| 30 C | 92.1 | 0.4 |
| 40 C | 87.4 | — |
| 50 C | 82.8 | — |

As shown in FIG. 11A and the Table 1, the lithium rechargeable battery according to Example 2 had larger discharge capacity than the one of Comparative Example 2 at a faster discharge rate. In particular, the lithium rechargeable battery of Example 2 had discharge capacity of 82.8 mAh/g at a fast discharge of 50 C-rate, which shows it had excellent discharge characteristics at a high rate.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material for a lithium rechargeable battery, comprising:
primary particles comprising a compound being capable of intercalating and deintercalating lithium; and
secondary particles comprising the primary particles gathered with one another,
wherein the secondary particles have a void core structure.

2. The positive active material of claim 1, wherein the primary particles comprise a lithium iron phosphate particle represented by the following Chemical Formula 1 and carbon:
Li₁₊ₐFe₁₋ₓMₓ(PO_{4-b})X_{b} [Reaction Scheme 1]
wherein, in Chemical Formula 1,
M is Al, Mg, Ni, Co, Mn, Ti, Ga, Cu, V, Nb, Zr, Ce, In, Zn, Y, or a combination thereof,
X is F, S, N, or a combination thereof, and
−0.5≦a≦0.5, 0≦x≦0.5, and 0≦b≦0.1.

3. The positive active material of claim 2, wherein the compound represented by Chemical Formula 1 comprises LiFePO₄.

4. The positive active material of claim 2, wherein the carbon is amorphous.

5. The positive active material of claim 2, wherein the carbon is present on a surface of the lithium iron phosphate particle.

6. The positive active material of claim 5, wherein the carbon is coated on a part or the entire surface of the lithium iron phosphate particle.

7. The positive active material of claim 6, wherein the carbon is coated in a thickness of 2 nm to 6 nm.

8. The positive active material of claim 1, wherein the primary particles have an average particle diameter of 25 nm to 70 nm.

9. The positive active material of claim 1, wherein the secondary particle has a spherical shape or an oval shape.

10. The positive active material of claim 1, wherein the secondary particles have a void space in the core part, which is formed by the connected surfaces of the primary particles gathered with one another.

11. The positive active material of claim 1, wherein the secondary particles have an average particle diameter of 200 nm to 500 nm.

12. The positive active material of claim 2, wherein the positive active material comprises 1 wt % to 5 wt % of carbon based on the total weight of the positive active material.

13. A method of preparing a positive active material for a lithium rechargeable battery, comprising:
preparing a first mixture comprising a first precipitate by mixing a lithium source, a phosphate source, and a solvent;
preparing a second mixture by mixing a carbon source, an iron source, and a solvent; and
preparing a second precipitate by mixing the first and second mixtures and forming a coprecipitate of the first and second precipitates.

14. The method of claim 13, wherein the lithium source is comprised in an amount of 5 wt % to 15 wt %, the phosphate source in an amount of 80 wt % to 85 wt %, and the solvent as a balance when the lithium source, the phosphate source, and the solvent are mixed to form the first precipitate.

15. The method of claim 13, wherein the lithium source comprises lithium hydroxide monohydrate (LiOH.H₂O), lithium hydroxide (LiOH), lithium nitrate (LiNO₃), lithium chloride (LiCl), or a combination thereof.

16. The method of claim 13, wherein the phosphate source comprises phosphoric acid (H₃PO₄), diammonium phosphate ((NH₄)₂HPO₄), ammonium phosphate trihydrate ((NH₄)₃PO₄.3H₂O), or a combination thereof.

17. The method of claim 13, wherein the first precipitate comprises lithium phosphate (Li₃PO₄).

18. The method of claim 13, wherein the carbon source is comprised in an amount of 25 wt % to 30 wt %, the iron source in an amount of 35 to 40 wt %, and the solvent as a balance when they are mixed to prepare a second mixture.

19. The method of claim 13, wherein the carbon source comprises a surfactant comprising a compound represented by the following Chemical Formula 2, a carbon gel, a carbohydrate, ascorbic acid, citric acid, or a combination thereof: 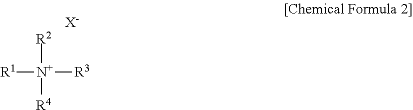
wherein, in Chemical Formula 2, R¹ to R⁴ are independently hydrogen or a substituted or unsubstituted C1 to C30 aliphatic organic group, and
X is F, Cl, Br, or I.

20. The method of claim 13, wherein the iron source comprises iron(II) sulfate heptahydrate (FeSO₄.7H₂O), ammonium iron(II) sulfate ((NH₄)₂Fe(SO₄)₂), or a combination thereof.

21. The method of claim 13, wherein the second precipitate comprises iron(II) phosphate (Fe₃(PO₄)₂).

22. The method of claim 13, wherein the solvent comprises H₂O, a polyol, or a combination thereof.

23. The method of claim 13, wherein the processes of mixing the first mixture with the second mixture to prepare a second precipitate and forming a coprecipitate of the first and second precipitates are performed at a temperature ranging from 20° C. to 40° C.

24. The method of claim 13, wherein the coprecipitate is hydrothermally reacted under a pressure ranging from 3 kPa to 4 kPa at a temperature ranging from 115° C. to 130° C.

25. The method of claim 13, wherein the coprecipitate is further heat treated.

26. The method of claim 25, wherein the heat treatment is performed under an inert or reduction atmosphere.

27. The method of claim 25, wherein the heat treatment is performed at a temperature ranging from 650° C. to 750° C.

28. A lithium rechargeable battery comprising:
a positive electrode comprising a positive active material;
a negative electrode comprising a negative active material; and
an electrolyte,
wherein the positive active material is the one according to claim 1.
